(19) United States
(12) Patent Application Publication
(10) Pub. No.: US 2002/0051077 A1
(43) Pub. Date: May 2, 2002

(54) Videoabstracts: a system for generating video summaries

(76) Inventors: Shih-Ping Liou, West Windsor, NJ (US); Candemir Toklu, Plainsboro, NJ (US); Madirakshi Das, Amherst, MA (US)

Correspondence Address: Siemens Corporation, Intellectual Property Department, 186 Wood Avenue South, Iselin, NJ, 08830, US

(21) Appl. No.: 09/908,930

(22) Filed: Jul. 19, 2001

Related U.S. Application Data
(60) Provisional application No. 60/219,196, filed on Jul. 19, 2000.

(51) Int. Cl. H04N 11/00; H04N 5/60

(52) U.S. Cl. 348/465; 348/738

(57) ABSTRACT

The present invention is directed to a system and method for comprehensively generating summaries of digital videos at various lengths and in different formats. In one aspect, the system analyzes closed-caption test to find summary sentence(s) for each story in the video, which are ordered in terms of their selection order. Upon selecting a presentation format, a set of images, video clips or an already-prepared video summary for each story is found. Text-to-speech tools can then be used to audit the summary sentences or capture the audio clips from the video with respect to the summary sentences.

This is a non-provisional application claiming the benefit of provisional application Ser. No. 60/219,196 entitled, Videoabstracts: A System For Generating Video Summaries, filed Jul. 19, 2000, which is hereby incorporated by reference.

### BACKGROUND

1. Technical Field

The present invention relates generally to the field of digital video processing and analysis, and in particular, to a system and method for generating multimedia summaries of videos and video stories.

2. Description of the Related Art

Video is being more widely used than ever in multimedia systems and is playing an increasingly important role in both education and commerce. Besides currently emerging services such as video-on-demand and pay-television, there are a large number of new non-television like information mediums such as digital catalogues and interactive multimedia documents which include text, audio and video.

However, these applications with digital video use time consuming fast forward or rewind mechanisms to search, retrieve and get a quick overview of the content. There is a need to come up with more efficient ways of accessing the video content. For example, a system that could present the audio-visual and textual information in compact forms such that a user can quickly browse a video clip, retrieve content in different levels of detail and locate segments of interest, would be highly desirable.

To enable this kind of access, digital video has to be analyzed and processed to provide a structure which allows the user to locate any event in the video and browse it very quickly. A popular method to provide the aforementioned needs is to organize the video based on stories and generate a video summary. Many applications need summaries of important video stories like, for example, broadcast news programs. Broadcast news providers need tools for browsing the main stories of a news broadcast in a fraction of the time desired for viewing the full broadcast, to generate a short presentation of major events gathered from different news programs or simply for use in indexing the video by content.

Different applications have different summary types and lengths. Video summaries may include one or more of the following: text from closed-caption data, key images, video clips and audio clips. Both text and audio clips may be derived in different ways: they could be extracted directly from the video, they could be constructed from the video data or they could be synthesized. The length of the summary may depend on the level of detail desired and the type of browsing environment.

The video summarization problem is often addressed by key-frame selection. One method, which is disclosed in, for example, U.S. Pat. No. 5,532,833 entitled “Method and System For Displaying Selected Portions Of A Motion Video”; the Mini-Video system described by Y. Taniguchi, A. Akutsu, Y. Tonomura, and H. Hamada in “An Intuitive and Efficient Access Interface to Real-time Incoming Video Based On Automatic Indexing,” Proc. ACM Multimedia, pp. 25-33, San Francisco, Calif., 1995; U.S. Pat. No. 5,635,982 entitled “System For Automatic Video Segmentation and Key-Frame Extraction For Video Sequences Having Both Sharp and Gradual Transitions”; and U.S. Pat. No. 5,664,227 entitled “System And Method For Skimming Digital Audio/Video Data”; summarizes the visual data present in the video as a sequence of images. Key-frame selection starts with scene change detection. Scene change detection provides low level semantics about the video. Both U.S. Pat. No. 5,532,833 and the Mini-Video system described above use key-frames that are selected at constant time-intervals in every video shot to build the visual summary. Irrespective of the content in the video shot, this method yields single/multiple key-frames.

Content-based key-frame selection is addressed in U.S. Pat. No. 5,635,982 and U.S. Pat. No. 5,664,227, both described above. These methods use various statistical measures to find the dissimilarity of images and heavily depend on the threshold selection. Hence, picking up the right threshold that will work for every kind of video is not trivial, since these thresholds cannot be linked semantically to events in the video; rather they are used to compare statistical quantities.

However, the content of the video is mainly presented by the audio component (or closed-captioned text for hearing impaired people). It is the images which mainly convey and help us to comprehend the emotions, environment, and flow of the story.

“Informedia” digital video library system described by A. G. Hauptmann and M. A. Smith in “Text, Speech, and Vision For Video Segmentation: The Informedia Project,” in Proc, of the AAAI Fall Symposium on Computational Models for Integrating Language and Vision, 1995, has shown that the combining of speech, text and image analysis can provide much more information, thus improving content analysis and abstraction of video as compared to using one media (for example, audio) only. This system uses speech recognition and text processing techniques to obtain the key words associated with each acoustic “paragraph” whose boundaries are detected by finding silence periods in the audio track. Each acoustic paragraph is matched to the nearest scene break, allowing the generation of an appropriate video paragraph clip in response to a user request. However, continuous speech recognition in uncontrolled environments has still yet to be achieved. Also, stories are not always separated by long silence periods. In addition, the accuracy of video summary generation at different granularities based on silence detection is questionable. Thus, the story segmentation based on silence detection, and the textual summary generation from the transcribed speech often fails.

The aftermentioned needs can be satisfied by using the closed-caption test information; hence, the limitations and problems associated with the Informedia system.

Accordingly, an efficient and accurate technique for generating video summaries, and in particular, summaries of digital videos, is highly desirable.

### SUMMARY OF THE INVENTION

The present invention is directed to a system and method for efficiently generating summaries of digital videos to archive and access them at different levels of abstraction.

It is an object of the present invention to provide a video summary generation system that addresses: a) textual summary generation; b) presentation of the textual summary using either clips from the audio track of the original video or text-to-speech synthesis; and c) generating summaries at different granularities based on the viewer's profile and needs. These requirements are in addition to the visual summary generation.

It is a further object of the present invention to use close-caption text and off-the-shelf natural language processing tools to find the real story boundaries in digital video, and generate the textual summary of the stories at different lengths. In addition, the present invention can use text-to-speech synthesis or the real audio clips corresponding to the summary sentences to present the summaries in the audio format and to address visual summary generation using key-frames.

It is also an object of the present invention to find repeating shots in the video and to eliminate them from the visual summary. In most cases the repeating shot (for example, such as an anchor person shot in a news broadcast or a story teller shot in documentaries) is not related to the story.

Advantageously, a system and method according to the present invention takes into account a combination of multiple sources of information, i.e., for example, text summaries, closed-caption data and images, to produce a comprehensive video summary which is relevant to the user.

In one aspect of the present invention, a method for generating summaries of a video is provided comprising the steps of: inputting summary sentences, visual information and a section-begin frame and a section-end frame for each story in a video; selecting a type of presentation; locating a set of images available for each story; auditing the summary sentences to generate an auditory narration of each story; matching said audited summary sentences with the set of images to generate a story summary video for each story in the video; and combining each of the generated story summaries to generate a summary of the video.

In yet another aspect of the present invention, a method for generating summaries of a video is provided comprising the steps of: inputting story summary sentences, video information and speaker segments for each story in a video; locating video clips for each story from said video information; capturing audio clips from the video clips, said audio clips corresponding to the summary sentences; combining said corresponding audio clips with the video clips to generate a story summary video for each story in the video; and combining each of the generated story summaries to generate a summary of the video.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 illustrates an exemplary block diagram of a closed-caption generator where an organized tree is generated based on processed closed caption data.

FIG. 2 depicts exemplary content processing steps preferred for extracting audio, visual and textual information of a video.

FIG. 3 is an exemplary illustration of various ways of using the audio, textual and visual information extracted using, for example, the method of FIG. 2 to create a story summary according to an aspect of the present invention.

FIG. 4 is an exemplary flow diagram of a method of generating a summary sentence for a story in a video according to an aspect of the present invention.

FIG. 5 is an exemplary flow diagram illustrating a method of generating or extracting video summaries according to an aspect of the present invention.

FIG. 6 depicts an exemplary process of generating an audio-visual summary for a single story in a video according to an aspect of the present invention.

FIG. 7 depicts an exemplary flow diagram illustrating a method of summary video extraction and generation using video clips according to an aspect of the present invention.

### DETAILED DESCRIPTION OF PREFERRED EMBODIMENTS

It is to be understood that the exemplary system modules and method steps described herein may be implemented in various forms of hardware, software, firmware, special purpose processors, or a combination thereof. Preferably, the present invention is implemented in software as an application program tangibly embodied on one or more program storage devices. The application program may be executed by any machine, device or platform comprising suitable architecture. It is to be further understood that, because some of the constituent system modules and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate or practice these and similar implementations or configurations of the present invention.

Briefly, a system according to the present invention includes a computer readable storage medium having a computer program stored thereon. The system preferably performs two steps. Initially, the system analyzes the closed-caption test with the off-the-shelf natural language summary generation tools to find summary sentence(s) for each story in the video. Then, the system generates or extracts the summary videos.

The first step is preferably performed by selecting the length of the story summaries by picking the number of summary sentences to compute, finding the summary sentence(s) using an off-the-shelf natural language summary generation tool, and ordering these summary sentences in terms of their selection order rather than time order. The second step is preferably performed by selected the type of the presentation form based on the resources, finding a set of images for each story among the representative frames and key-frames of the shots associated with the story or capture its summary from the video itself if the summary of stories in the video are a part of the whole video, and using a text-to-speech engine to audit the summary sentences or capture the audio clips from the video regarding the summary sentences.

An overall summary of a program is generated by summarizing the main stories comprising the program. In the case where closed-caption data is available for the video, the summary can include text in addition to images, video clips and audio.

The first step in generating video summaries is to find the stories in the video and associate audio, video and closed-caption text to each story. One method for organizing a video into stories is outlined in U.S. patent application Ser. No. 09/602,721, entitled, “A System For Organizing Videos Based On Closed-Caption Information”, filed on Jun. 26, 2000, which is commonly assigned and the disclosure of which is herein incorporated by reference.

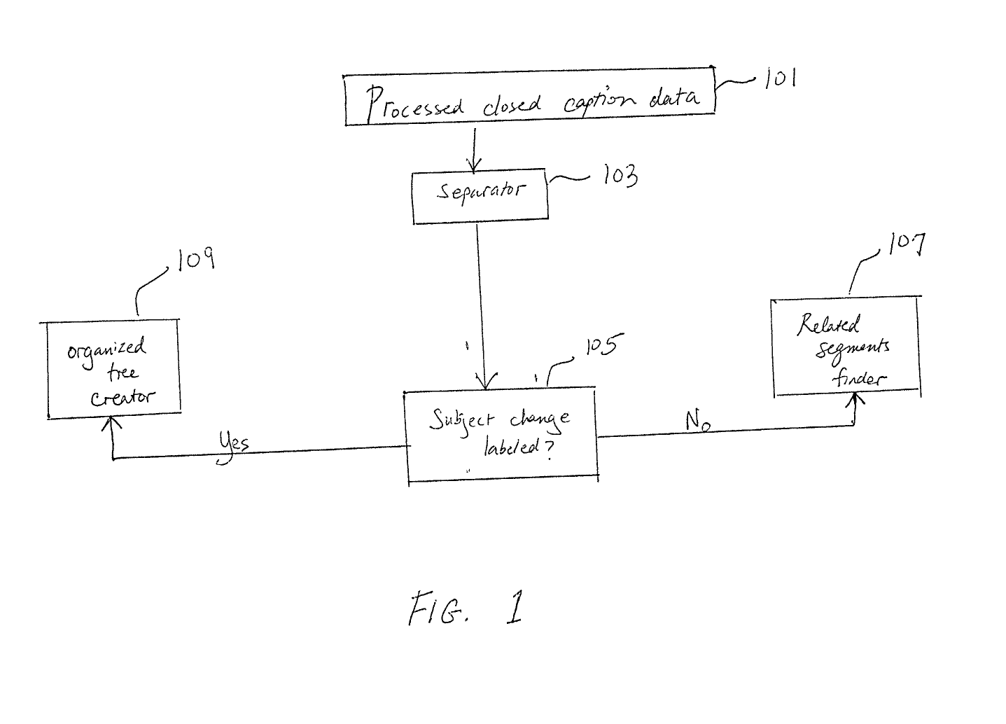

FIG. 1 illustrates an exemplary block diagram of a closed-caption generator described in the above-incorporated U.S. patent application Ser. No. 09/602,721, where an organized tree is generated based on processed closed caption data 101. The organized tree is used to provide summaries of the main stories in the video in the form of text and images in the case where closed caption text is available. Referring to FIG. 1, the method that is used to construct the organized tree from the processed closed caption data depends on whether a change of subject starting a new story is marked by a special symbol in the closed-caption data. This occurs in separator 103, which separates segments based on closed-caption labels.

Through subject change decision 105, if a change of subject is labeled, each new subject is attached to the root node as a different story. This occurs in organized tree creator 109. Each story may have one or more speaker segments, which are attached to the story node. Thus, the organized tree comprises a number of distinct stories with different speakers within the same story. Organized tree creator 109 creates an organized tree with each subject as a separate node, including related speakers within the subject node.

When subject changes are not labeled in the closed-caption data, the only segments available as inputs are speaker segments. In this case, it is preferable to group speakers into stories. This occurs in related segments finder 107. This grouping is done on the assumption that there will be some common elements within the same story. The common elements used can be, for example, proper nouns in the text. The same story will usually have the same persons, places and organizations mentioned repeatedly in the body of the text. These elements are matched to groups speaker segments into stories. Related segments finder 107 therefore finds related segments using proper nouns and groups them into separate tree nodes. Once stories have been identified, the tree construction is the same as described above.

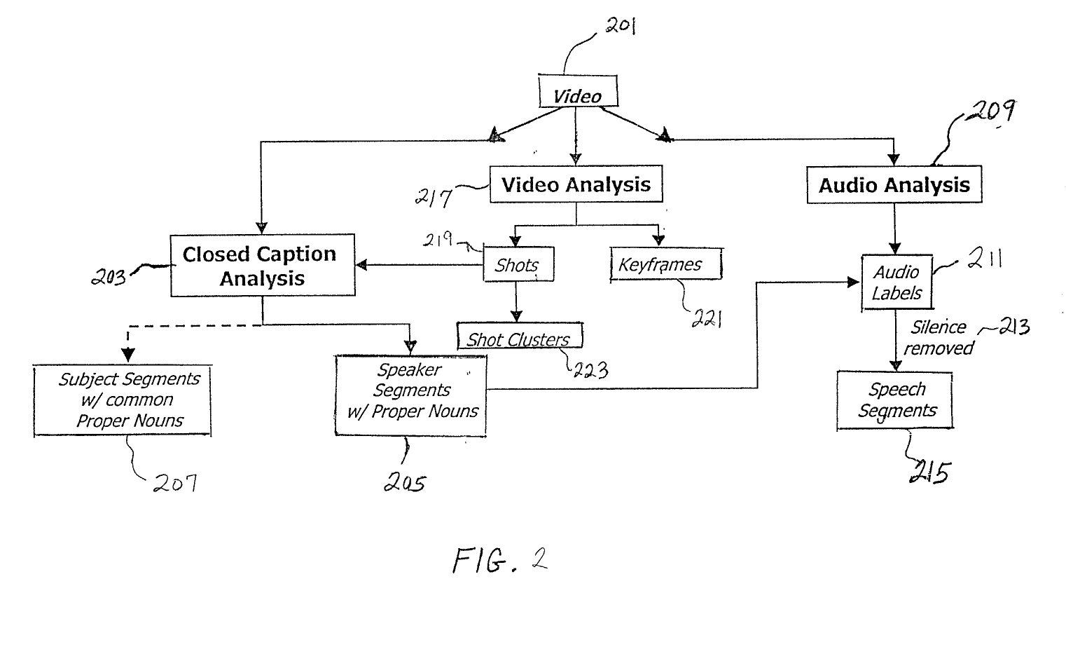

FIG. 2 depicts preferred content processing steps for extracting audio, visual and textual information of a video 201. Such content processing is preferred before generating story summaries of a video. Closed caption text is entered into closed-caption analyzer 203 where the text is analyzed to detect the speaker segments with proper nouns 205 and subject segments with common proper nouns 207 as described, for example, in the above-incorporated pending U.S. patent application Ser. No. 09/602,721. Closed-caption text provides the approximate beginning and end frames of each speaker segment.

Video 201 is also input to audio analysis 209 for generating audio labels 211. The audio labels 211 are generated by labeling audio data with speech, i.e., isolating an audio track corresponding to each speaker segment 205. This isolation can be done by detecting silence regions in the neighborhood of the beginning and ending frames for the speaker segment 205. Then, speech segments 215 can be generated for each speaker by eliminating the silent portions (step 213) of the audio data.

For generating a visual component of the summary, it is preferable to have, for example, a list of key images generated from the video frames. Through video analysis 217, a representative icon (e.g., the image corresponding to the first frame of each shot) is found for each shot 219 in the video. Video analysis 217 may also provide key frames 221, which are additional frames from the body of the shot. Key frames 221 are preferably stored in a keyframelist database. These additional frames are created when there is more action in the shot than can be captured in a single image from the beginning of the shot. This process is described in detail in pending U.S. patent application Ser. No. 09/449,889, entitled “Method and Apparatus For Selecting Key-frames From A Video Clip,” filed on Nov. 30, 1999, which is commonly assigned and the disclosure of which is herein incorporated by reference. The representative frames and keyframelist provide a list of frames available for the video. From this list, a set of images for summary generation can be selected.

It is possible to generate a variety of video summaries using the list of key-frames 221, speech segments 215, summary sentences and/or video clips. The final form and length of the video summaries will be based on the requirements of each application and the level of detail preferred. For example, a short summary may contain about two lines of text with four frames per story, whereas a longer, more detailed summary, may contain up to five lines of text and eight frames.

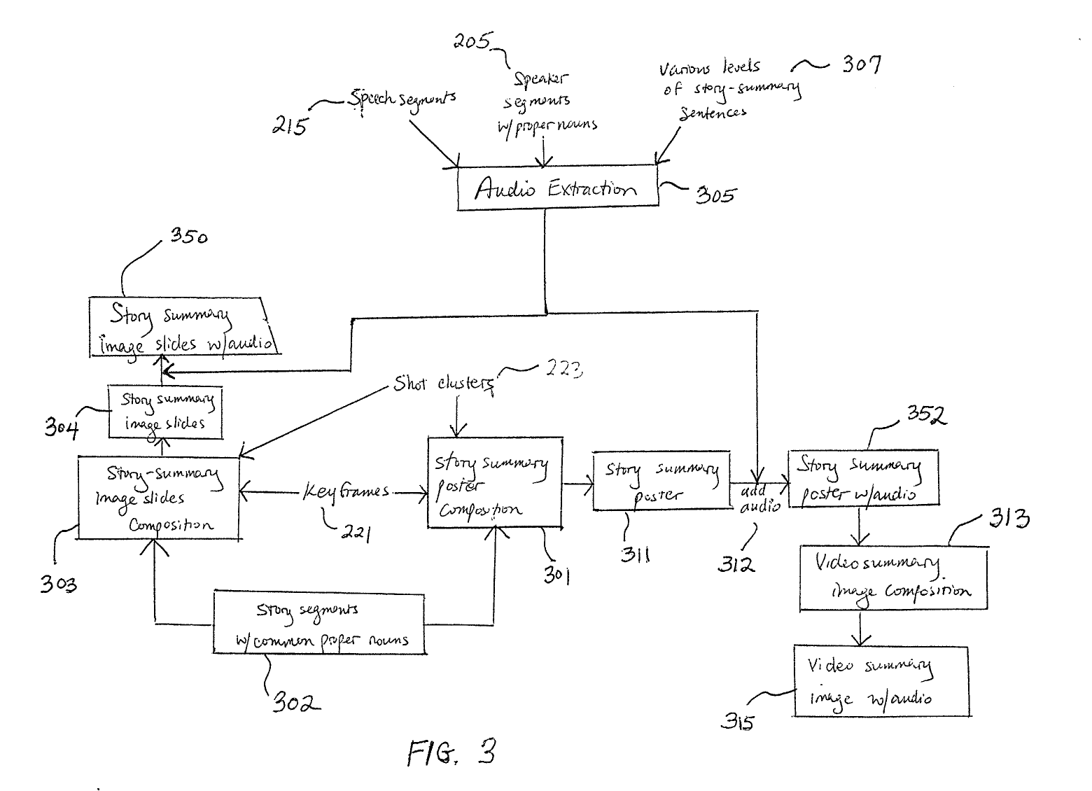

FIG. 3 is an exemplary illustration of various ways of using the audio, textual and visual information extracted using, for example, the method of FIG. 2 to create a story summary according to an aspect of the present invention. Images generated to describe a story can be presented as, for example, a sequence in a slide-show format (for example, by ordering images related to the story) such as story-summary w/audio 350 or in a poster format (e.g., by pasting images related to the story inside a rectangular frame) such as story-summary poster w/audio 352.

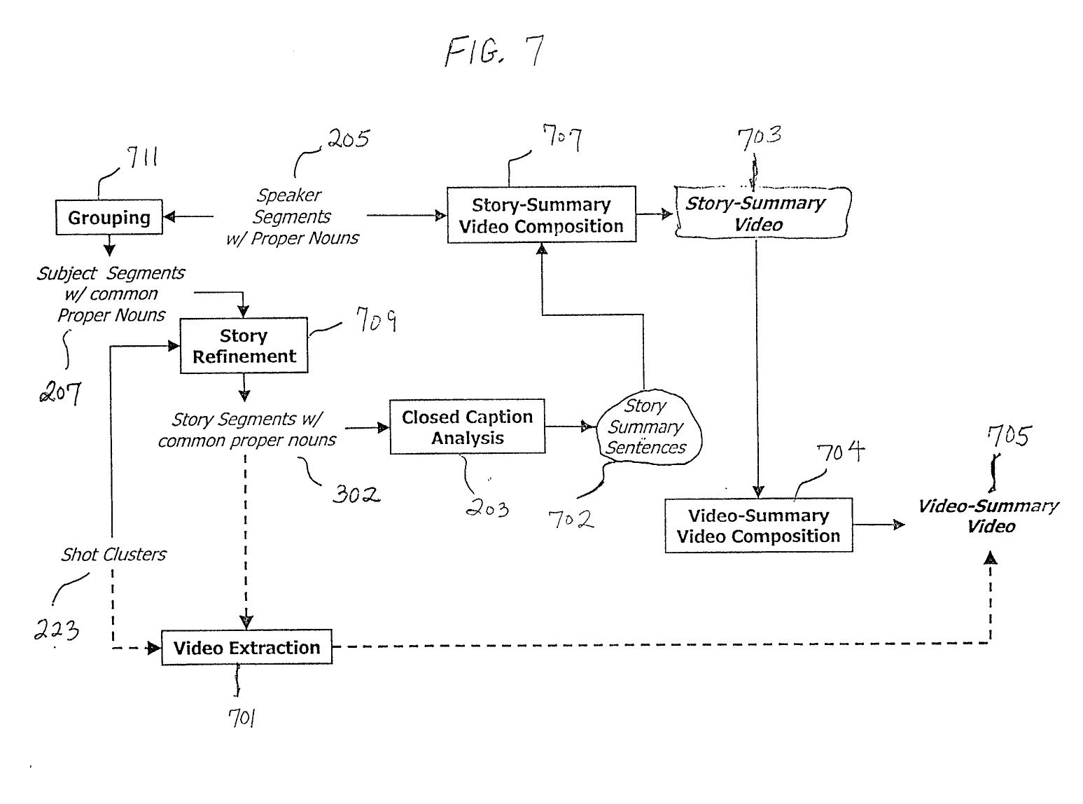

For producing either story-summary poster with audio 352 or story-summary image slides w/audio 350, shot clusters and key frames generated from video analysis 217 as well as story segments w/common proper nouns 302 are provided to story-summary poster composition 301 and story-summary image slides composition 303, respectively. Story segments with common proper nouns 302 are generated, for example, by a method described in FIG. 7 below. Speech segments 215, speaker segments w/proper nouns 205 and various levels of story summary sentences 307 are provided to audio extraction 305. The story summary sentences can be generated, for example, using off-the-shelf text summary generation tools. In story-summary image slides composition 303, a set of images corresponding to each story is found among the shot clusters 223 and keyframes 221. This results in story-summary image slides 304. Next, in step 309, audio corresponding to the story summary sentences 307 is added as narration from audio extraction 305. This results in story-summary image slides with audio 350.

As stated above, instead of a slide-show format, a composite image can be created in a poster format from the list of images generated from video analysis 217 and the audio segments added to the story summary poster. As with the slide show, shot clusters 223 and keyframes 221 that are preferably generated from video analysis 217 of FIG. 2, and story segments w/common proper nouns (207), are provided to story-summary poster composition 301 which outputs story-summary poster 311. Audio segments 215, speaker segments w/proper nouns 205 and various levels of story summary sentences 307 are provided to audio extraction 305. The output audio provided by audio extraction 305 is then combined with the story-summary poster 311 (step 312) to form story-summary poster w/audio 352. A summary of the video can then be composed, for example, by combining several story-summary posters w/audio 352 in video-summary image composition 313. The output is video-summary image with audio 315. In addition, it is to be noted that a summary of the video can also be created in the image-slide format by combining several story summary image slides w/audio 350 using the video summary image composition 313.

It is to be noted that if audio segments are not used, the textual summary obtained for each story may be transformed into audio using any suitable text-to-speech system so that the final summary can be an audio-visual presentation of the video content.

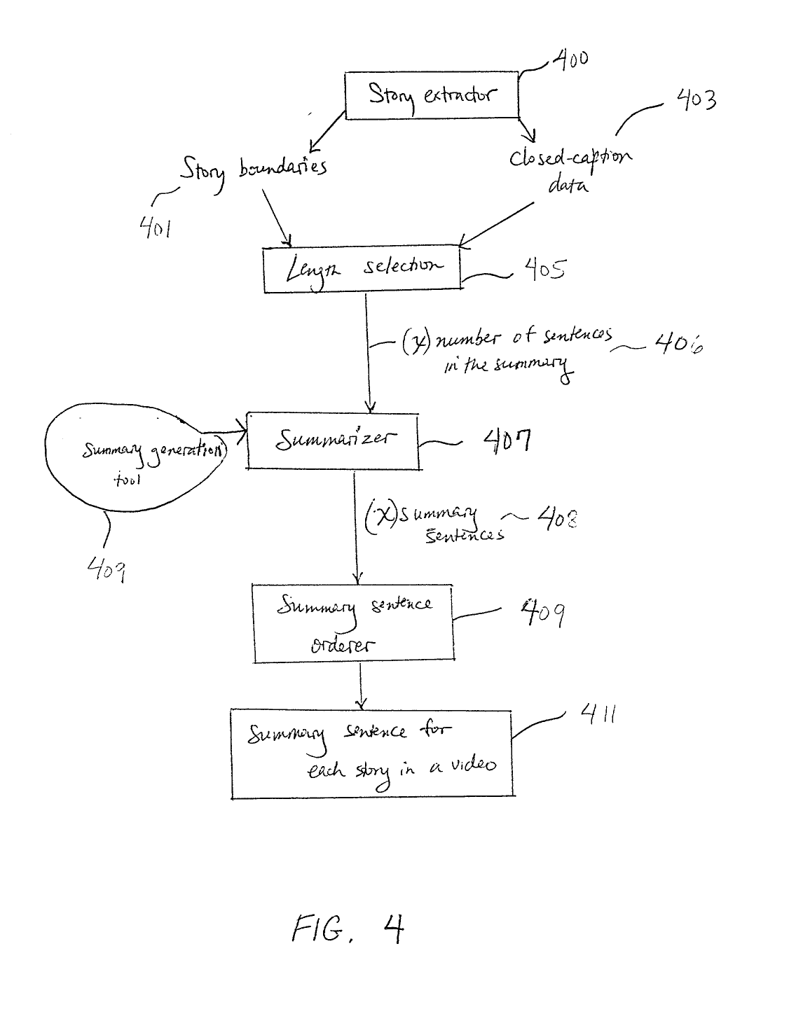

FIG. 4 is an exemplary flow diagram of a method of generating a summary sentence for a story in a video according to an aspect of the present invention. Initially, story extractor 400 produces story boundaries 401 and closed-caption data 403, which are provided as input to a length selection decision 405. A preferred method employed by the story extractor 400 is described in detail in the above-incorporated U.S. patent application Ser. No. 09/602,721. Story boundaries comprise, for example, information which outlines the beginning and end of each story. This information may comprise, for example a section-begin frame and a section-end frame, which are determined by analyzing closed-caption text.

In length selection decision 405, a length of the summary can be indicated by a user. The user, for example, may indicate (x) number of sentences to be selected for the summary of each story, where x is any integer greater than or equal to one (step 406). Next, in summarizer 407 a group of sentences corresponding to each story is analyzed to generate x number of sentences (step 408) as the summary sentence(s) for each story using, for example, any suitable conventional text summary generation tool 409.

In summary sentence orderer 409, the summary sentences can be ordered based on, for example, their selection order rather than their time order. The selection order is preferably determined by the text summary generation tool, which ranks the summary sentences in order of their importance. This is in contrast to ordering based on time order, which is simply the order in which the summary sentences appear in the video and/or closed-caption text. The resulting output is a summary sentence for each story in the video (step 411).

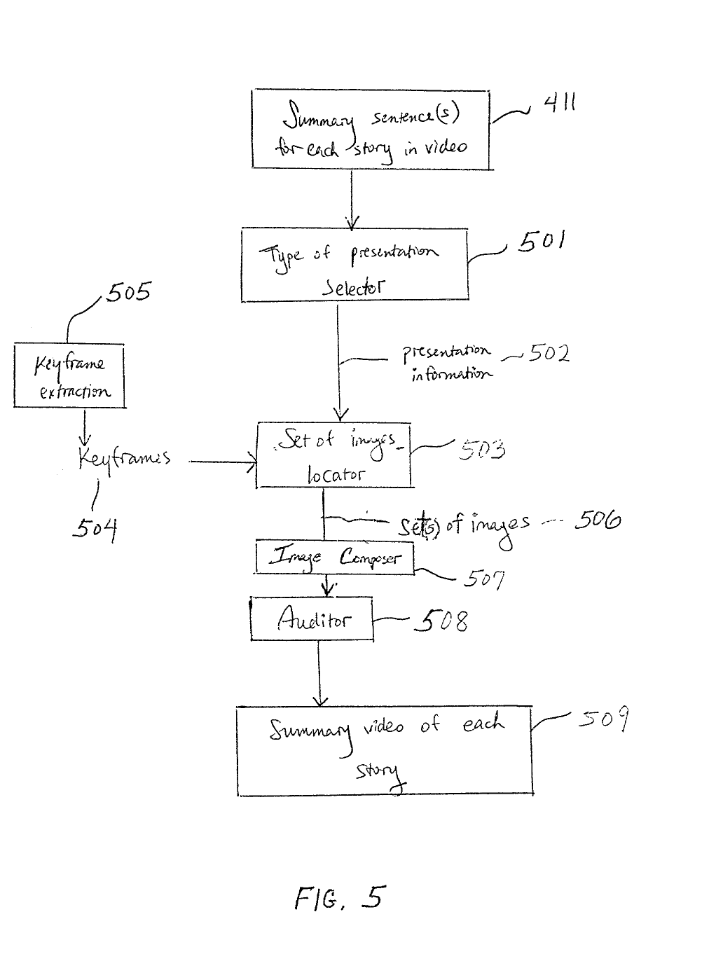

FIG. 5 is an exemplary flow diagram illustrating a method of generating or extracting video summaries according to an aspect of the present invention. Initially, the summary sentence(s) 411 for each story in a video is provided to a presentation selector 501, which allows the user to select a type of presentation, for example, a slide-show presentation or a poster image. Depending on the type of presentation chosen, the presentation information 502 (e.g., an image slide format or poster format) is provided to set of images locator 503 for generating or extracting the images corresponding to the summary sentences 411 for each story. The set of images is generated, for example, by video analysis 217, in which keyframes 504 are extracted using, for example, a keyframe extraction process 505. A preferred keyframe extraction process 505 is described in detail in the above-incorporated U.S. application Ser. No. 09/449,889.

At least one set of images 506 is produced from the locator 503. The set of images 506 is then input into an image composer 507 for matching the set of images to the story summary sentences 411. Next, the summary sentences are audited in auditor 508 to generate an auditory narration of the story summary. Together with its corresponding processed set of images 506, the auditory narration results in a summary video of each story 509.

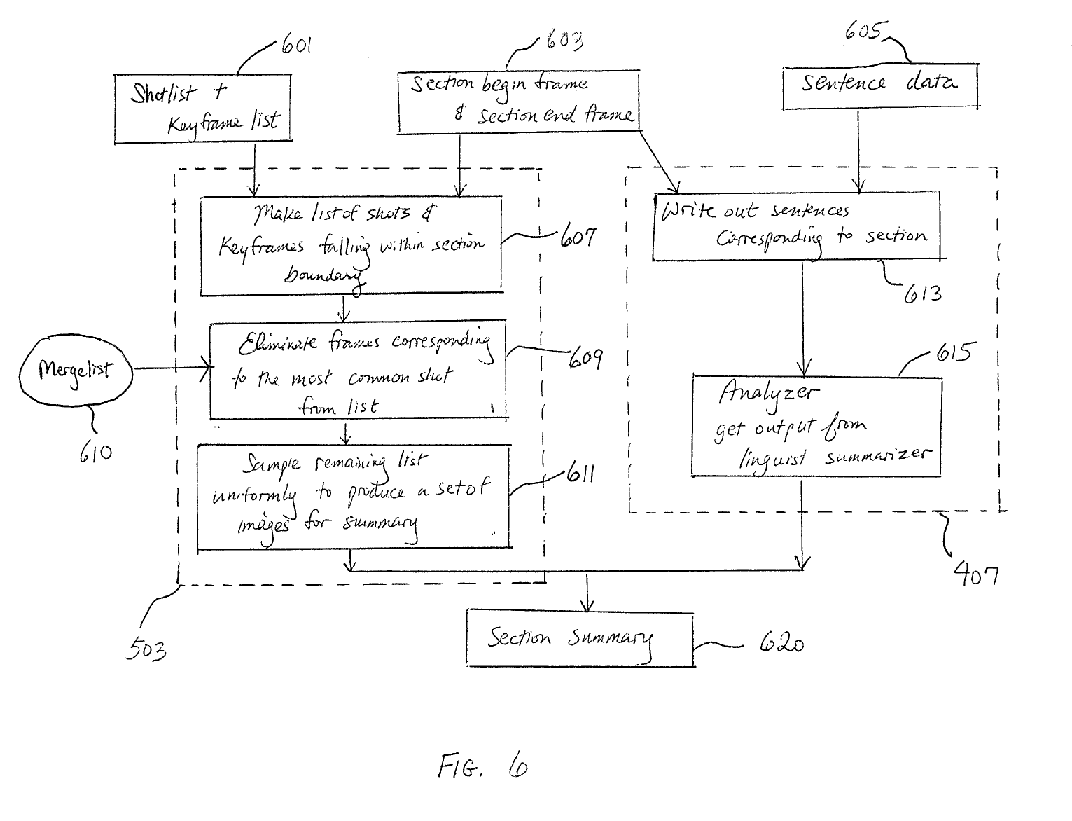

FIG. 6 depicts an exemplary process of generating an audio-visual summary for a single story in a video according to an aspect of the present invention. Initially, the shotlist and the keyframelist 601 (generated, for example by video analysis 217), section begin frame/section end frame 603 and sentence data 605 are inputs. In step 607, an initial list of images available for the story is obtained by listing all representative frames and key-frames falling within the boundary of the section (i.e., story). For example, in a news broadcast scenario, this list of icon images may contain many images (i.e., repeating shots) of the anchor-person delivering the news in a studio setting. These images are not useful in providing glimpses of the story being described and will not add any visual information to the summary if they are included. Thus, it is preferable to eliminate such images before proceeding.

Thereafter, the repeating shots are detected and a mergelist file 610 is generated which shows the grouping obtained when the icon images corresponding to each shot are clustered into visually similar groups. This process of using repeating shots to organize the video is described in pending U.S. patent application Ser. No. 09/027,637 entitled “A System For Interactive Organization And Browsing Of Video,” filed on Feb. 23, 1998 which is commonly assigned and the disclosure of which is herein incorporated by reference.

Then, the full list of icon images is scanned, and in step 609, any image belonging, for example, to the largest visually similar group is deleted from the list (i.e., the frames corresponding to the most visually similar shots in the initial list are eliminated). This process is analogous, for example, to the process used in indexing text databases, where the most frequently occurring words are eliminated because they convey the least amount of information.

In step 611, the remaining list of images is sampled to produce a set of images for the summary presentations. In one embodiment, this can be done, for example, by sampling uniformly with the sampling interval being determined by the number of images desired for the given length of the summary. In another embodiment, the location (in terms of their frame number) of the proper nouns generated from the closed caption analysis can be used to make a better selection of frames to represent the story. The frames at these points are expected to capture the proper noun being mentioned concurrently and therefore, are important from the point of view of summarizing the important people, places, etc. present in the video. It is to be noted that steps 607, 609 and 611 depict an exemplary process of the set of images locator 503.

If closed-caption data is available, summary sentences are also generated along with the summary images. This part of the summary uses sentence data generated for example, from closed-caption analysis 203. In step 613, a group of sentences corresponding to a section (story) is written out and analyzed in analyzer 615 to generate a few sentences as the summary. This can be performed, for example, by using an off-the-shelf text summary generation tool. The number of sentences in the summary can be specified by the user, depending on the level of detail desired in the final summary. The set of images generated by step 611 is then matched with its corresponding summary sentences generated by steps 613 and 615 to result in a section (i.e., story) summary 620.

In another embodiment of the present invention, instead of using static images in the summary, it is also possible to use video clips extracted from the full video to summarize the content of the video. FIG. 7 depicts an exemplary flow diagram illustrating a method of summary video extraction and generation using video clips according to an aspect of the present invention.

In the simplest case, the video itself may contain a summary, which can be extracted through video extraction 701. This is true for some news videos (e.g. CNN) which broadcast a section highlighting the main stories covered in the news program at the beginning of the program. In the example of CNN broadcasts, this summary is terminated by the appearance of the anchor-person which signals the beginning of the main body of the news program. Some other news programs provide summaries when returning from advertisement breaks or at the end of the broadcast. In such cases, it would be simple to extract and use these summaries to provide the final video summary.

When the video does not include any summary video segments, it is also possible to generate summary video clips for each story and link them together to produce the overall video summary. Speaker segments with proper nouns 205 is input for grouping 711. The grouping step 711 groups speaker segments into story segments by finding story boundaries using, for example, a process described in FIG. 1. This results in subject segments with common proper nouns 207, which is input together with shot clusters 223 into story refinement 709 for generating the story segments with common proper nouns 302.

Story segments with common proper nouns 302 is then processed by closed caption analysis 203 which uses, for example, the process described in FIG. 4 to generate story summary sentences 702. The story summary sentences are preferably ranked, for example, in a selection order (i.e., they have some importance attached to them). Story summary video composition 707 uses the speaker segments 205 and the story summary sentences 702 together with the video input provided by the shot clusters 223 to capture the audio clips from the video regarding the story summary sentences, thus generating a story summary video 703. (Since the summary sentences are considered to be the important parts of the video, the video portions can be used from the location of the story summary sentences 702). The complete video summary video 705 comprises a concatenation of summaries (performed in step 704) from individual story-summary videos 703.

In conclusion, the present invention provides a system and method for summarizing videos that are segmented into story units for archival and access. At the lowest semantic level, one can assume each video shot to be a story. Using repeating shots, the video can be segmented into stories using the techniques described in U.S. patent application Ser. No. 09/027,637 entitled “A System For Interactive Organization And Browsing Of Video,” filed on Feb. 23, 1998 which is commonly assigned and the disclosure of which is herein incorporated by reference.

The video can also be segmented into stories manually. Advantageously, this provides control over the length of the summary. The summary presentation can be chosen among various formats based on the network constraints. Compared to previous approaches, closed-caption information can be used, if it is available, to coordinate the summary generation process. In addition, summary generation at different abstraction levels and types is also addressed by controlling summary length and presentation types, respectively. For example, in a very low bandwidth network, one can use only the image form for visual presentation and local text-to-speech engine for auditory narration. In this situation the user has to download only the summary sentences and a poster image. In a high bandwidth network, one can use the video form as the summary. Using the slideshow presentation for visual content and original audio clips for summary sentences, one can fill rest of the bandwidth with the optimum type of presentation format.

It is to be noted that the video summary can be presented to the user as streaming video using, for example, off-the-shelf tools.

Although illustrative embodiments of the present invention have been described herein with reference to the accompanying drawings, it is to be understood that the present invention is not limited to those precise embodiments, and that various other changes and modifications may be affected therein by one skilled in the art without departing from the scope or spirit of the present invention. All such changes and modifications are intended to be included within the scope of the invention as defined by the appended claims.

What is claimed is:

1. A method for generating summaries of a video comprising the steps of:
inputting summary sentences, visual information and a section-begin frame and a section-end frame for each story in a video;
selecting a type of presentation;
locating a set of images available for each story;
auditing the summary sentences to generate an auditory narration of each story;
matching said audited summary sentences with the set of images to generate a story summary video for each story in the video; and
combining each of the generated story summaries to generate a summary of the video.

2. The method of claim 1, wherein the visual information comprises at least one of a shotlist, a keyframelist and a combination thereof.

3. The method of claim 1, wherein the summary sentences are generated by:
generating story boundaries and sentence data using a story extractor;
selecting a length of a story summary;
summarizing said sentence data to produce at least one summary sentence, wherein a number of the summary sentences produced corresponds to the length of the story summary; and
ordering the at least one summary sentence based on its selection order.

4. The method of claim 1, wherein the type of presentation comprises an image slide format.

5. The method of claim 1, wherein the type of presentation comprises a poster format.

6. The method of claim 1, wherein the section-begin frame and the section-end frame determines a story boundary.

7. The method of claim 1, wherein the step of locating the set of images further comprises the steps of:
collecting a list of images within a story boundary;
generating a mergelist for clustering images corresponding to each shot into visually similar groups;
deleting images belonging to a largest visually similar group; and
sampling a remaining list of images to produce the set of images.

8. The method of claim 7, wherein the sampling is performed uniformly with a sampling interval determined by a number of images desired for a given length of story summary.

9. The method of claim 7, wherein the step of sampling further comprises selecting a frame number of each proper noun.

10. A method for generating summaries of a video, comprising the steps of:
inputting story summary sentences, video information and speaker segments for each story in a video;
locating video clips for each story from said video information;
capturing audio clips from the video clips, said audio clips corresponding to the summary sentences;
combining said corresponding audio clips with the video clips to generate a story summary video for each story in the video; and
combining each of the generated story summaries to generate a summary of the video.

11. The method of claim 10, wherein the summary sentences are generated by:
generating story boundaries and sentence data using a story extractor;
selecting a length of a story summary;
summarizing said sentence data to produce at least one summary sentence, wherein a number of the summary sentences produced corresponds to the length of the story summary; and
ordering the at least one summary sentence based on its selection order.

12. A program storage device readable by a machine, tangibly embodying a program of instructions executable by the machine to perform method steps for generating summaries of a video, the method steps comprising the steps of:
providing summary sentences, visual information and a section-begin frame and a section-end frame for each story in a video;
selecting a type of presentation;
locating a set of images available for each story;
auditing the summary sentences to generate an auditory narration of each story; and
matching said audited summary sentences with the set of images to generate a story summary video for each story in the video, wherein a summary of the video is generated by combining each of the generated story summaries.

13. The program storage device of claim 12, wherein the visual information comprises at least one of a shotlist, a keyframelist and a combination thereof.

14. The program storage device of claim 12, wherein the instructions for generating summary sentences comprise instructions for performing the steps of:
generating story boundaries and sentence data using a story extractor;
selecting a length of a story summary;
summarizing said sentence data to produce at least one summary sentence, wherein a number of the summary sentences produced corresponds to the length of the story summary; and
ordering the at least one summary sentence based on its selection order.

15. The program storage device of claim 12, wherein the type of presentation comprises an image slide format.

16. The program storage device of claim 12, wherein the type of presentation comprises a poster format.

17. The program storage device of claim 12, wherein the section-begin frame and the section-end frame determines a story boundary.

18. The program storage device of claim 12, wherein the step of locating the set of images further comprises the steps of:
collecting a list of images within a story boundary;
generating a mergelist for clustering images corresponding to each shot into visually similar groups;
deleting images belonging to a largest visually similar group; and
sampling a remaining list of images to produce the set of images.

19. The program storage device of claim 18, wherein the sampling is performed uniformly with a sampling interval determined by a number of images desired for a given length of story summary.

20. The program storage device of claim 18, wherein the step of sampling further comprises selecting a frame number of each proper noun.
